(19) United States
(12) Patent Application Publication
(10) Pub. No.: US 2026/0027975 A1
(43) Pub. Date: Jan. 29, 2026

(54) VEHICLES INCLUDING TRUCK BED WITH DEPLOYABLE STORAGE BIN

(71) Applicant: Toyota Motor Engineering & Manufacturing North America, Inc., Plano, TX (US)

(72) Inventors: Justin B. Norris, Brighton, MI (US); James D. Cunningham, Clarkston, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/787,444

(22) Filed: Jul. 29, 2024

(51) Int. Cl. B60R 9/06; B60R 5/04

(52) U.S. Cl. CPC B60R 9/065; B60R 5/045

(57) ABSTRACT

A vehicle includes a truck bed including a bed deck with a bed deck lid configured to move between a closed position covering a compartment below the bed deck and an open position exposing the compartment through the bed deck. A storage system includes a bin assembly located in the compartment. The bin assembly includes a bin configured to hold one or more cargo items and a linkage assembly operatively connected to the bin. The linkage assembly configured to raise the bin assembly from a stowed configuration with the bin recessed into the compartment and the bed deck lid in the closed position to a deployed configuration at least partly outside the compartment with the bed deck lid in the open position.

### TECHNICAL FIELD

The present specification generally relates to storage systems for truck beds and, more specifically, to truck beds with deployable and stowable storage bins.

### BACKGROUND

Pickup trucks often have truck beds that are used to carry cargo from one place to another. During movement of the trucks, the cargo can move around in the truck beds if left unrestrained, which can cause noise and may also damage the cargo and/or truck bed. Further, the cargo may move to the front of the truck bed which can reduce accessibility to the cargo when the cargo is removed from the truck beds. In some instances, it may even be necessary to climb into the truck beds to access the cargo and remove the cargo from the truck beds. Accordingly, what is needed are storage systems that can be used to store cargo while in the truck beds.

### SUMMARY

In accordance with one embodiment, a vehicle includes a truck bed including a bed deck with a bed deck lid configured to move between a closed position covering a compartment below the bed deck and an open position exposing the compartment through the bed deck. A storage system includes a bin assembly located in the compartment. The bin assembly includes a bin configured to hold one or more cargo items and a linkage assembly operatively connected to the bin. The linkage assembly configured to raise the bin assembly from a stowed configuration with the bin recessed into the compartment and the bed deck lid in the closed position to a deployed configuration at least partly outside the compartment with the bed deck lid in the open position.

In accordance with another embodiment, a method of moving cargo within a truck bed of a truck using a storage assembly is provided. The method includes opening a bed deck lid from a closed position to an open position thereby exposing a bin assembly located within a compartment below the bed deck. The bin assembly includes a bin configured to hold one or more cargo items and a linkage assembly operatively connected to the bin. The linkage assembly is configured to raise the bin assembly from a stowed configuration with the bin recessed into the compartment and the bed deck lid in the closed position to a deployed configuration at least partly outside the compartment with the bed deck lid in the open position. The bin is lifted from the stowed configuration to the deployed configuration using the linkage assembly.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following description of the illustrative embodiments can be understood when read in conjunction with the following drawings, where like structure is indicated with like reference numerals and in which:

FIG. 1 schematically depicts a rear view of a pickup truck having a truck bed with storage system in a stowed configuration, according to one or more embodiments shown and described herein;

FIG. 2 schematically depicts a rear view of the pickup truck of FIG. 1 with a bin assembly of the storage system in an intermediate configuration partially raised, according to one or more embodiments shown and described herein;

FIG. 3 schematically depicts a rear view of the pickup truck of FIG. 2 with the bin assembly of the storage system in a deployed configuration, according to one or more embodiments shown and described herein;

FIG. 4 schematically depicts the bin assembly of FIG. 3 in isolation in the stowed configuration, according to one or more embodiments shown and described herein; and

FIG. 5 schematically depicts the bin assembly of FIG. 3 in isolation in the deployed configuration, according to one or more embodiments shown and described herein.

### DETAILED DESCRIPTION

Pickup trucks according to the present specification are vehicles that include a passenger cabin and a truck bed located rearward of the passenger cabin. The truck bed includes a bed deck that includes a bed deck lid configured to cover a compartment in the bed deck. The bed deck lid has a closed position and an open position. The bed deck lid may be operably connected to a bin assembly located within the compartment such that a linkage lifts the bin assembly at least partially out of the compartment as the bed deck lid is raised to the open position.

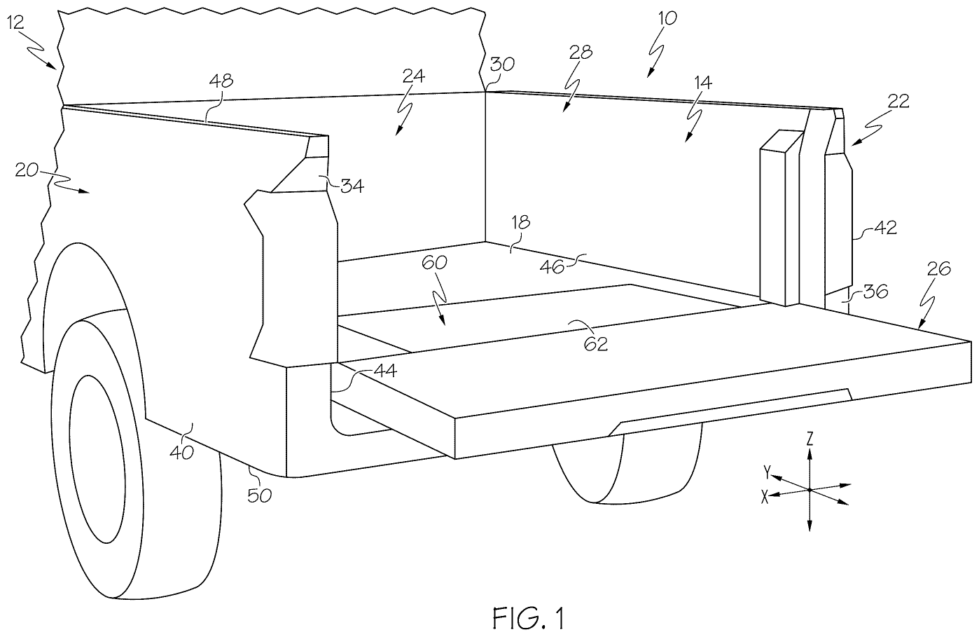

As used herein, the term “vehicle longitudinal direction” refers to the forward-rearward direction of the pickup truck (i.e., in the vehicle Y direction depicted in FIG. 1). The term “vehicle lateral direction” refers to the cross-pickup truck direction (i.e., in the vehicle X direction depicted in FIG. 1), and is transverse to the vehicle longitudinal direction. The term “vehicle vertical direction” refers to the upward-downward direction of the pickup truck (i.e., in the vehicle Z-direction depicted in FIG. 1). As used herein, “upper,” “over” and “above” are defined as the positive Z direction of the coordinate axis shown in the drawings. “Lower,” “under,” and “below” are defined as the negative Z direction of the coordinate axis shown in the drawings.

Referring to FIG. 1, the terms “outboard” or “outward” as used herein refers to the relative location of a component in a direction with respect to a pickup truck centerline. The term “inboard” or “inward” as used herein refers to the relative location of a component in a direction with respect to the pickup truck centerline. Because the pickup truck structures may be generally symmetrical about the pickup truck centerline, the direction to which use of terms “inboard,” “inward,” “outboard” and “outward” refer may be mirrored about the pickup truck centerline when evaluating components positioned along opposite sides of the pickup truck 10.

The pickup truck 10 includes a passenger cabin 12 and a truck bed 14. The truck bed 14 includes a bed deck 18 (i.e., a floor), a pair of spaced apart sidewalls 20, 22, a front wall 24, and a rear wall 26. The floor 18, the sidewalls 20, 22, the front wall 24, and the rear wall 26 define a storage area 28 of the truck bed 14.

The sidewalls 20, 22 extend parallel to the vehicle longitudinal direction. Each sidewall 20, 22 includes a front end 30 and an opposite rear end 34, 36 that forms a rear pillar of the truck bed 14. The front wall 24 extends between the front ends 30, 32 of the sidewalls 20, 22. The rear wall 26 extends between the rear ends 34, 36 of the sidewalls 20, 22.

In some embodiments, it is appreciated, that the rear wall 26 is pivotally connected to the sidewalls 20, 22 as a tailgate for movement between a closed position and an open position. In the closed position, the rear wall 26 extends parallel to the vehicle vertical direction. In the open position, the rear wall 26 extends parallel to the vehicle longitudinal direction.

The sidewalls 20, 22 include an exterior wall panel 40, 42 and an opposite interior wall panel 44, 46. The sidewalls 20, 22 include upper ends 48 and opposite lower ends 50. The lower ends 50 are positioned closer to the bed deck 18 of the truck bed 14 than the upper ends 48. The sidewalls 20 and 22 may include a sidewall cover that is used to cover the upper ends 48.

In some embodiments, a truck bed cover may be releasably connected to the sidewalls 20 and 22 and extends over the truck bed 14. The truck bed cover can include at least one panel that may be hingedly or otherwise attached to the front wall 24 to allow for moving the truck bed cover between open and closed configurations. In the example of FIG. 1, the truck bed does not have a truck bed cover is in the closed configuration.

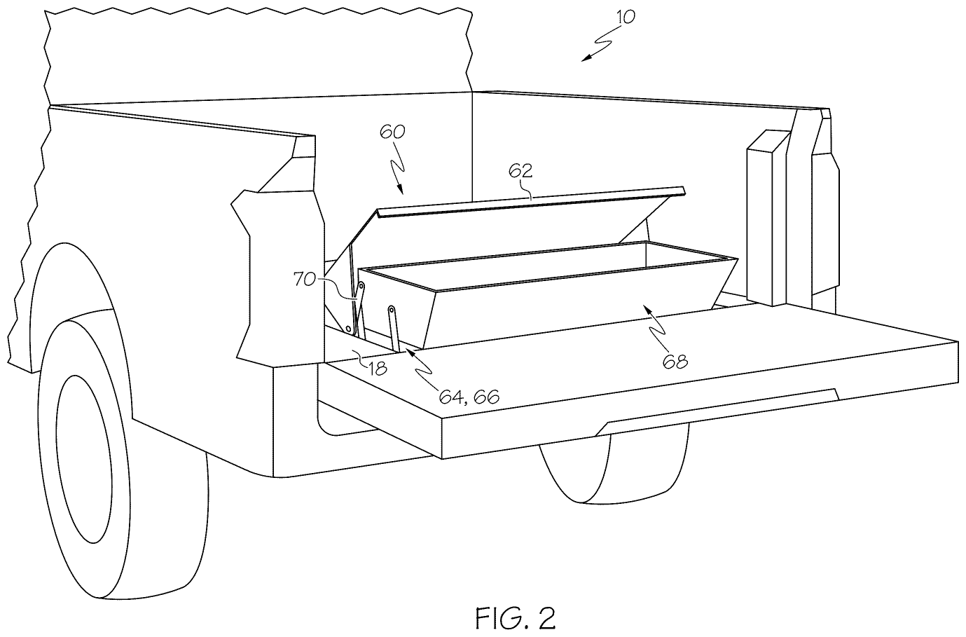

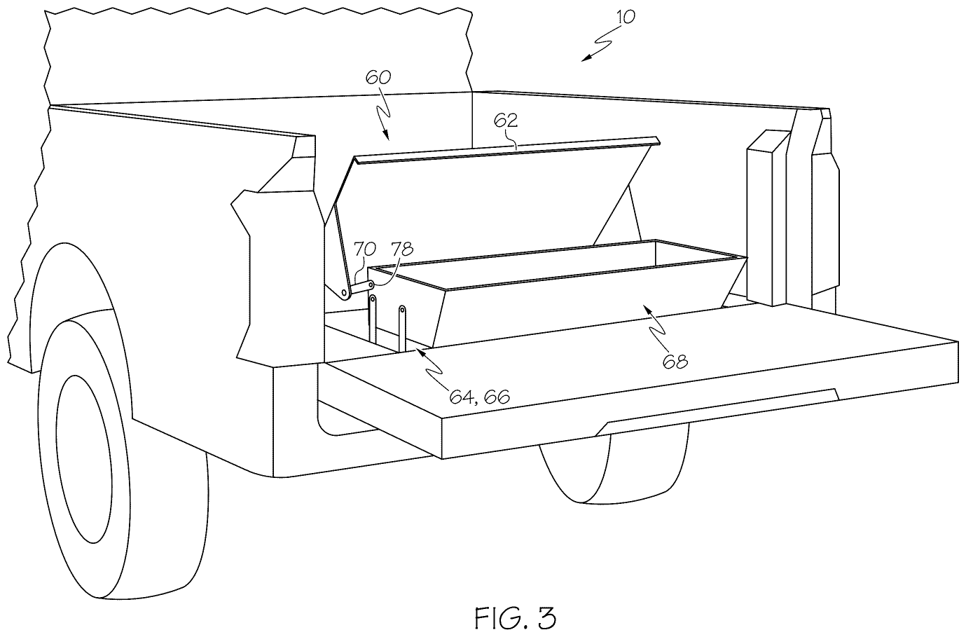

Referring also to FIG. 2, the pickup truck 10 includes a storage system 60. In particular, the bed deck 18 includes a bed deck lid 62 that is configured to cover a compartment opening 64 in the bed deck 18. The bed deck lid 62 has a closed position (FIG. 1) that covers a compartment 66 and an open position (FIG. 3) the exposes the compartment 66. The compartment 66 may be part of the bed deck 18 or formed separately from the bed deck 18 and attached thereto using any suitable connection, such as fasteners, welding, etc. The bed deck lid 62 may be operably connected to a bin assembly 68 located within the compartment 66 such that a linkage arm 70 lifts the bin assembly 68 at least partially out of the compartment 66 as the bed deck lid 62 is raised to the open position. FIG. 1 illustrated the bin assembly 68 in a stowed configuration, FIG. 2 illustrates the bed deck lid 62 and bin assembly 68 in a partially raised, intermediate configuration and FIG. 3 illustrates the bed deck lid 62 and bin assembly 68 in a fully raised, deployed configuration with the bed deck lid 62 in the open position.

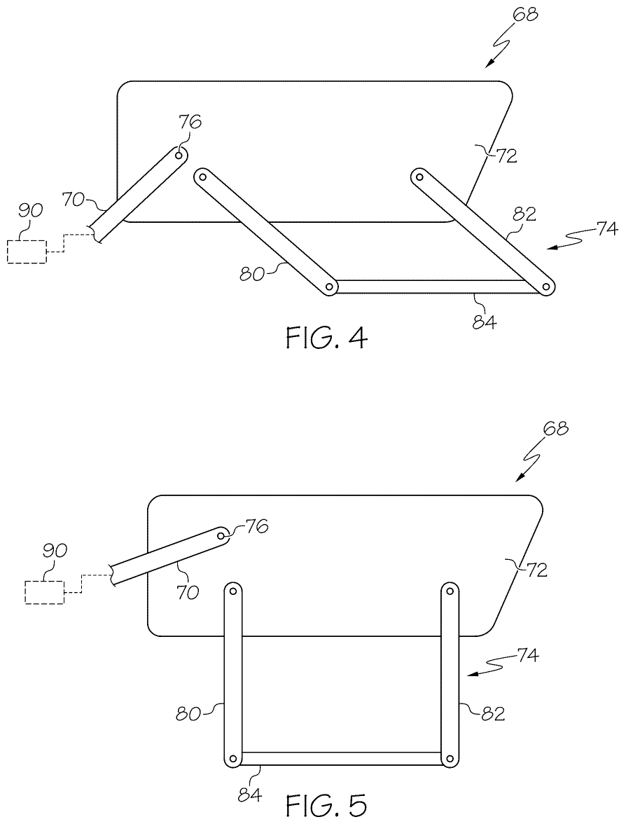

Referring to FIGS. 4 and 5, the bin assembly 68 includes a bin 72 that is pivotally connected to the linkage arm 70 at a pivot location 76 that is also pivotally connected to the bed deck lid 62 at another pivot location 78 (FIG. 3). A linkage assembly 74, such as a four-bar type linkage, is also pivotally connected to the bin 72. While only one linkage assembly 74 is shown of one side of the bin assembly 68 the opposite side of the bin assembly 68 may have a similar or the same linkage assembly 68. Any suitable linkage arrangement can be used that can be used to raise the bin 72. In this example, the linkage assembly 74 includes pivot bars 80 and 82 that can pivot relative to fixed linkage 84. The fixed linkage 84 may be mounted to the compartment 66, or the compartment 66 itself may form the fixed linkage 84. The fourth bar of the four-bar linkage can be the bin 72 itself, or another linkage. As can be appreciated, as the bed deck lid 62 is raised, the linkage arm 70 pivots from an initial position (FIG. 4) toward a raised position (FIG. 5). The linkage transfers a lifting force from the bed deck lid 62 to the bin 72 and then to the pivot bars 80 and 82, which cause the bin 72 to lift at least partially out of the compartment 66. In some embodiments, one or more actuators 90, such as a gas assist damper and/or a power spindle, may be operatively connected to the bin assembly 68 and/or the bed deck lid 62 to aid in opening and/or closing the bed deck lid 62 and/or lifting the bin assembly 68. In another embodiment, the linkage arm 70 may be omitted and the bin assembly 68 may be raised manually.

FIGS. 1-5 also show a method of moving cargo using the storage assembly 68 by opening the bed deck lid 62 from a closed position to an open position. In some embodiments the bed deck lid 62 may be operatively connected to the storage assembly 68 such that opening the bed deck lid 62 lifts the storage assembly 68 from the stowed configuration with the bin 72 recessed below a top surface of the bed deck 18 to a deployed configuration with the bin 72 at least partially above the top surface of the bed deck 18. Further, as can be seen in FIGS. 4 and 5, the linkage assembly 74 also cause the bin 72 to move rearward, as represented by arrow 92 of FIG. 5, to bring the bin nearer to a rear edge 94 of tailgate 26 (FIGS. 1-3).

The above-described storage systems include bin assemblies that include storage bins that can be raised and lowered using linkage assemblies. The storage systems described herein can aid in providing access to cargo in the storage bins, which can provide a more ergonomic system for storing and accessing the cargo. Particularly, the storage systems can lift and move the cargo closer to a rear edge of an open tailgate for easier access.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle comprising:
a truck bed comprising a bed deck comprising a bed deck lid configured to move between a closed position covering a compartment below the bed deck and an open position exposing the compartment through the bed deck; and
a storage system comprising a bin assembly located in the compartment, the bin assembly comprising:
a bin configured to hold one or more cargo items; and
a linkage assembly operatively connected to the bin, the linkage assembly configured to raise the bin assembly from a stowed configuration with the bin recessed into the compartment and the bed deck lid in the closed position to a deployed configuration at least partly outside the compartment with the bed deck lid in the open position.

2. The vehicle of claim 1 further comprising a linkage arm that is operatively connected to the bed deck lid and the bin assembly, wherein the lid and linkage arm are configured to raise the bin assembly from the stowed configuration to the deployed configuration as the bed deck lid is moved from the closed position to the open position.

3. The vehicle of claim 2, wherein the linkage arm is pivotally connected to the bed deck lid at a first pivot location and is pivotally connected to the bin at a second pivot location.

4. The vehicle of claim 1, wherein the linkage assembly comprises a four bar linkage.

5. The vehicle of claim 1, wherein the linkage assembly comprises a fixed linkage that is fixed relative to the storage compartment and a pivot linkage that is pivotally connected to the fixed linkage.

6. The vehicle of claim 5, wherein the pivot linkage is pivotally connected to the storage bin.

7. The vehicle of claim 6 comprising a pair of pivot linkages pivotally connected to the fixed linkage and the storage bin.

8. A method of moving cargo within a truck bed of a truck using a storage assembly, the method comprising:
opening a bed deck lid from a closed position to an open position thereby exposing a bin assembly located within a compartment below the bed deck, the bin assembly comprising:
a bin configured to hold one or more cargo items; and
a linkage assembly operatively connected to the bin, the linkage assembly configured to raise the bin assembly from a stowed configuration with the bin recessed into the compartment and the bed deck lid in the closed position to a deployed configuration at least partly outside the compartment with the bed deck lid in the open position; and
lifting the bin from the stowed configuration to the deployed configuration using the linkage assembly.

9. The method of claim 8, wherein the bed deck lid is operatively connected to the bin assembly by a linkage causing the step of lifting the bin assembly as the bed deck lid is opened.

10. The method of claim 8, further comprising moving the bin rearward using the linkage assembly during the step of lifting the bin assembly.
